(19) United States
(12) Patent Application Publication
(10) Pub. No.: US 2023/0397017 A1
(43) Pub. Date: Dec. 7, 2023

(54) TECHNIQUES FOR ENERGY SIGNAL GENERATION AND INTERFERENCE CANCELATION

(71) Applicant: QUALCOMM Incorporated, San Diego, CA (US)

(72) Inventors: Ahmed ELSHAFIE, San Diego, CA (US); Sony AKKARAKARAN, Poway, CA (US); Yuchul KIM, San Diego, CA (US); Yu ZHANG, San Diego, CA (US); Seyedkianoush HOSSEINI, San Diego, CA (US); Linhai HE, San Diego, CA (US); Huilin XU, Temecula, CA (US)

(21) Appl. No.: 17/805,326

(22) Filed: Jun. 3, 2022

(51) Int. Cl. H04W 24/02; H04W 72/04; H04L 5/00; H02J 50/00

(52) U.S. Cl. CPC H04W 24/02; H04W 72/042; H04L 5/0048; H02J 50/001

(57) ABSTRACT

Certain aspects of the present disclosure provide techniques for generating energy signals and interference cancellation. An example method includes transmitting, to a network entity, an indication of a preferred configuration for transmission of an energy signal to power one or more components of the first UE and receiving the energy signal from the network entity based, at least in part, on the preferred configuration.

### BACKGROUND

### Field of the Disclosure

Aspects of the present disclosure relate to wireless communications, and more particularly, to techniques for generating energy signals and interference cancellation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE). The method includes transmitting, to a network entity, an indication of a preferred configuration for transmission of an energy signal to power one or more components of the first UE and receive the energy signal from the network entity based, at least in part, on the preferred configuration

One aspect provides a method for wireless communication by a second user equipment (UE). The method includes receiving, from a network entity, an indication of a selected configuration of an energy signal for powering a first UE, the selected configuration of an energy signal including a set of parameters, receiving one or more transmissions from the network entity, the one or more transmissions including the energy signal and one or more data signals, and performing an interference cancellation procedure based on the selected configuration of the energy signal to remove interference caused by the energy signal to the one or more data signals.

One aspect provides a method for wireless communication by a network entity. The method includes receiving, from a first use equipment (UE), an indication of a preferred configuration for transmission of an energy signal to power one or more components of the first UE and transmitting the energy signal based, at least in part, on the preferred configuration

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates a radio frequency identification (RFID) system.

FIG. 5B illustrates an example topographies for circuitry of an RFID reader and for the energy harvesting circuitry.

FIGS. 6A, 6B, and 6C illustrate different methods for multiplexing energy signals and data signals.

FIG. 7 depicts a process flow for communications in a network between a network entity, a first user equipment, and a second user equipment.

FIG. 8 depicts a method for wireless communications.

FIG. 9 depicts another method for wireless communications.

FIG. 10 depicts another method for wireless communications.

FIG. 11 depicts aspects of an example communications device.

FIG. 12 depicts aspects of another example communications device.

### DETAILED DESCRIPTION

Aspects of the present disclosure provide apparatuses, methods, processing systems, and computer-readable mediums for generating energy signals and interference cancellation.

Radio frequency identification (RFID) is a rapidly growing technology impacting many industries due to its economic potential for inventory/asset management within warehouses, interne of things (IoT), sustainable sensor networks in factories and/or agriculture, and smart homes, to name a few example applications. RFID technology consists of RFID devices, such as transponders, or tags, that emit an information-bearing signal upon receiving an energizing signal. RFID devices may be operated without a battery at low operating expense, low maintenance cost, and with a long-life cycle. Generally, RFID devices that operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device.

Fifth and later generations of wireless technology may be expanded to support devices that are capable of harvesting energy from alternative energy sources (e.g., in lieu of or in combination with a battery). For example, similar to the RFID devices described above, these fifth and later generation devices may not include a local power storage component and may instead harvest energy from things such as RF signals, thermal energy, solar energy, etc.

When RF signals are used for harvesting energy, a first device may transmit an energy signal to a second device, which may harvest energy from the energy signal to power one or more other components of the second device. In some cases, energy signals may be multiplexed with data signals and transmitted using the same time and/or frequency resources. In some cases, multiplexing the energy signals with the data signals may be performed to more efficiency use time-frequency resources within a wireless network. In some cases, multiplexing the energy signals with the data signals may also be performed so that the second device can be powered on via the energy signal and able to receive the data signals at the same time.

In some cases, however, these energy signals have the potential to cause interference to the data signals, which may negatively affect an ability of a receive device to properly receive and decode the data signals. This may lead to retransmissions of the data signals due to improperly received original transmissions of the data signals. These retransmissions unnecessarily consume time-frequency resources within a wireless communication network as well as power resources at both the transmit device and receive device. Moreover, these retransmissions increase latency wireless communications, leading to poor user experience.

Accordingly, aspects of the present disclosure provide techniques for reducing interference caused by the transmission of energy signals within a wireless communication network for powering certain wireless communication devices. In some cases, the techniques presented herein may involve a first user equipment (UE) transmitting, to a network entity, an indication of a preferred configuration for an energy signal to be transmitted by the network entity. The network entity may then select a configuration for the energy signal (e.g., based on the preferred configuration received from the first UE) and transmit an indication of the selected configuration for the energy signal to the first UE and a second UE. Thereafter, when transmitting one or more transmissions to the first UE and the second UE, such as the energy signal and one or more data signals, the second UE may use the selected configuration for the energy signal to cancel interference caused by the energy signal to the one or more data signals. In some cases, the first UE may also perform a similar interference cancellation procedure if the first UE is capable of receiving the one or more data signals.

The techniques described herein for selecting and indicating the configuration for the energy signal enable devices, such as fifth and later generation devices, to effectively cancel interference caused by an energy signal, which in-turn improves the probability that data signals are properly received and decoded by the devices. Further, because interference caused by the energy signal may be more effectively canceled according to aspects described herein, the number of retransmissions of these the data signals may be reduced, thereby conserving time-frequency resources within the wireless communications network and conserving power resources among the devices communicating in the wireless communications network.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

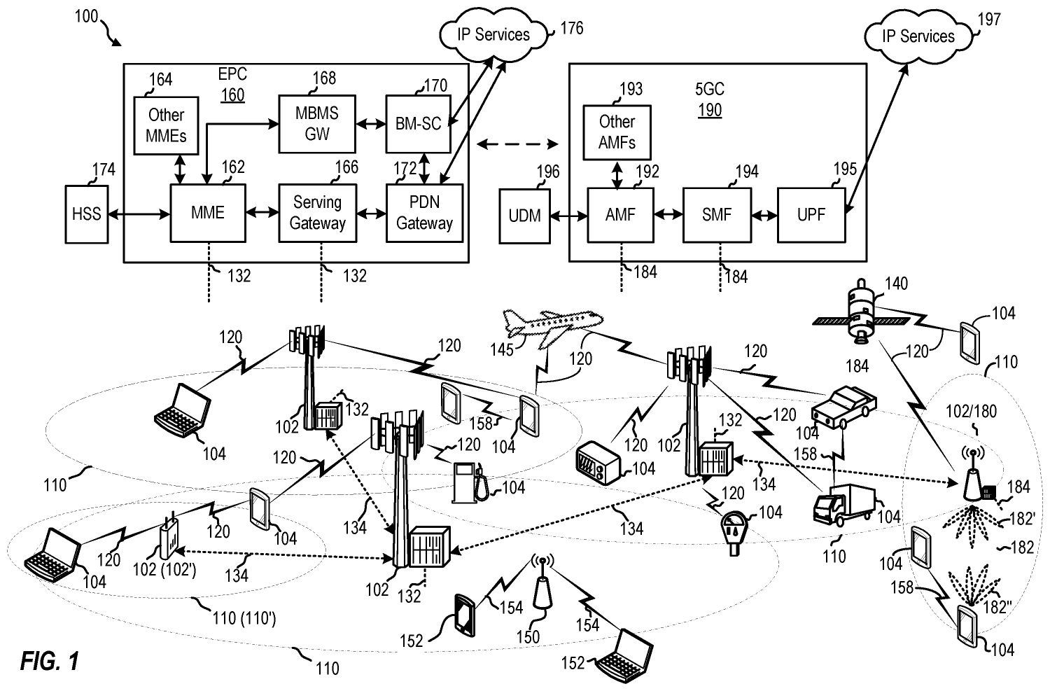

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

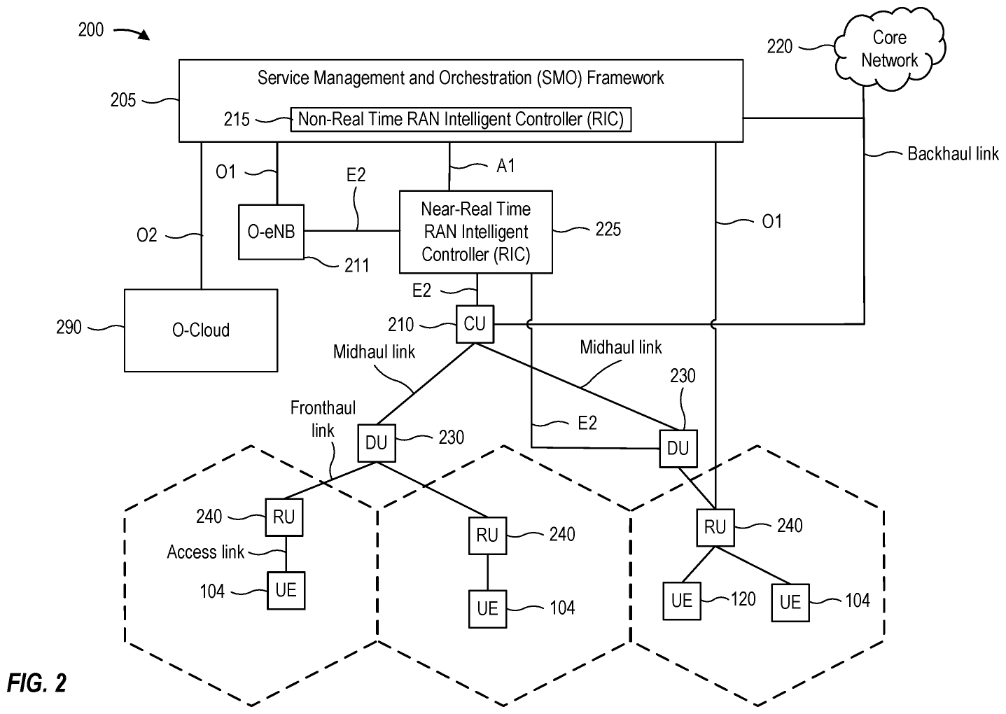

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (Ai/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT MC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

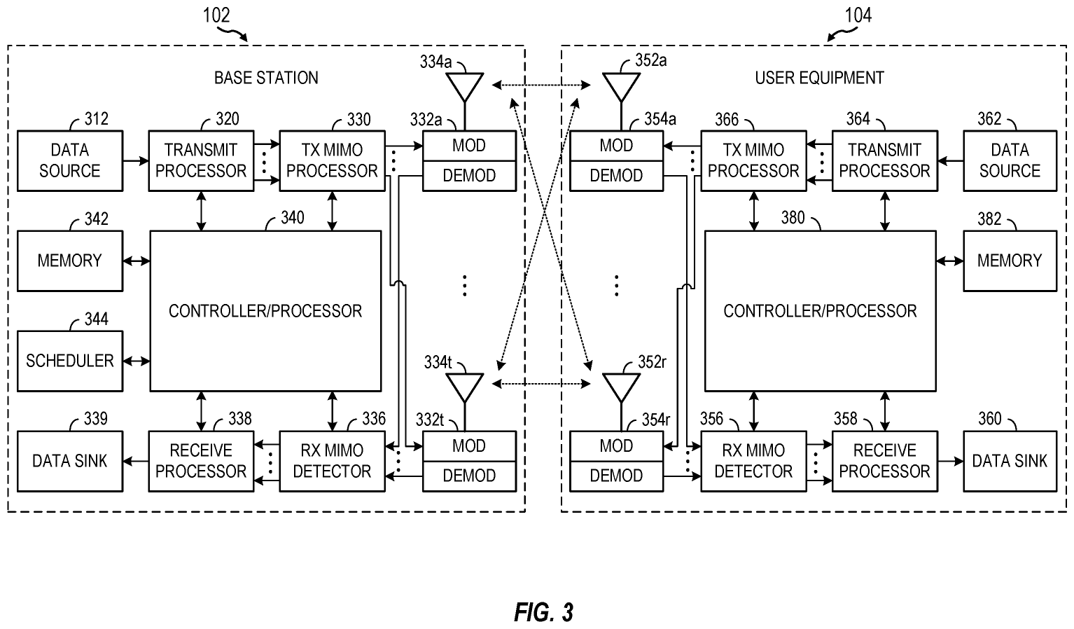

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

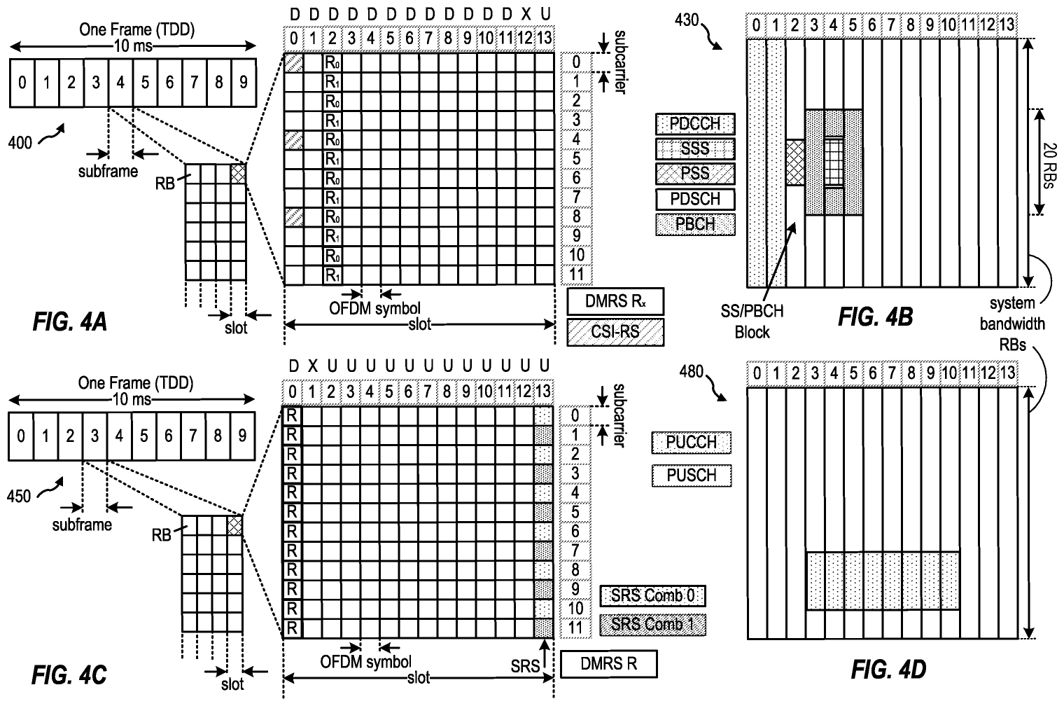

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of sub carriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in Radio Frequency Identification Systems

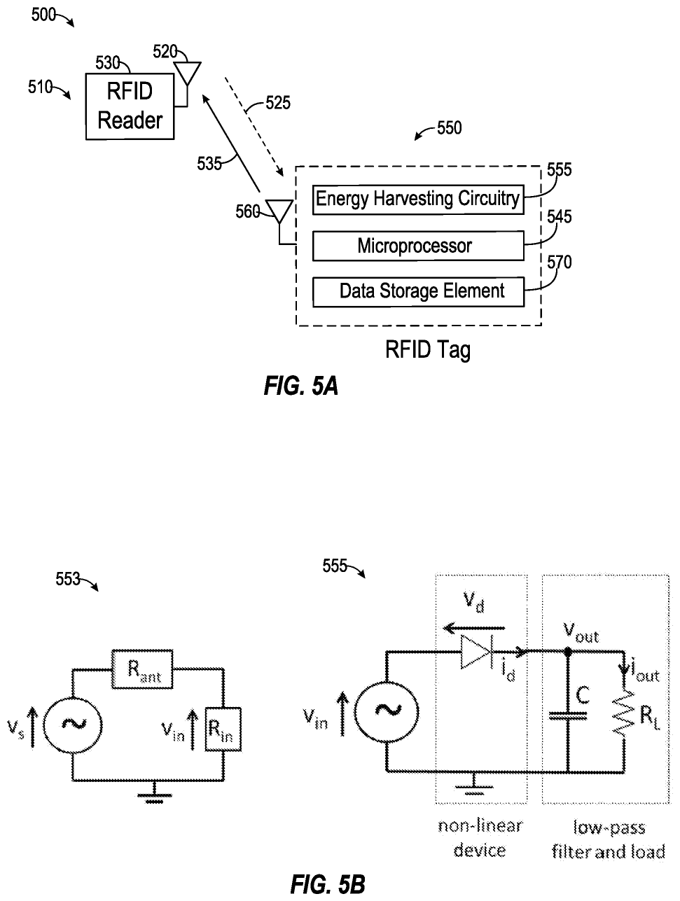

FIG. 5A shows a radio frequency identification (RFID) system 500. As shown, the RFID system 500 includes an RFID reader 510 and an RFID tag 550. The RFID reader 510 may also be referred to as an interrogator or a scanner. The RFID tag 550 may also be referred to as an RFID label or an electronics label.

The RFID reader 510 includes an antenna 520 and an electronics unit 530. The antenna 520 radiates signals transmitted by the RFID reader 510 and receives signals from RFID tags and/or other devices. The electronics unit 530 may include a transmitter and a receiver for reading RFID tags such as the RFID tag 550. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by the RFID reader 510.

As shown, the RFID tag 550 includes an antenna 560 and a data storage element 570. The antenna 560 radiates signals transmitted by the RFID tag 550 and receives signals from the RFID reader 510 and/or other devices. The data storage element 570 stores information for the RFID tag 550, for example, in an electrically erasable programmable read-only memory (EEPROM) or another type of memory. The RFID tag 550 may also include an electronics unit that can process the received signal and generate the signals to be transmitted. The RFID tag 550 may be a passive RFID tag having no battery. In this case, induction may be used to power the RFID tag 550. For example, in some cases, a magnetic field from a signal transmitted by RFID reader 510 may induce an electrical current in RFID tag 550, which may then operate based on the induced current. The RFID tag 550 can radiate its signal in response to receiving a signal from the RFID reader 510 or some other device.

In one example, the RFID tag 550 may be read by placing the RFID reader 510 within close proximity to the RFID tag 550. The RFID reader 510 may radiate a first signal 525 via the antenna 520. In some cases, the first signal 525 may be known as an interrogation signal or energy signal. In some cases, energy of the first signal 525 may be coupled from the RFID reader antenna 520 to RFID tag antenna 560 via magnetic coupling and/or other phenomena. In other words, the RFID tag 550 may receive the first signal 525 from RFID reader 510 via antenna 560 and energy of the first signal 525 may be harvested using energy harvesting circuitry 555 and used to power the RFID tag 550.

For example, energy of the first signal 525 received by the RFID tag 550 may be used to power a microprocessor 545 of the RFID tag 550. The microprocessor 545 may, in turn, retrieve information stored in a data storage element 570 of the RFID tag 550 and transmit the retrieved information via a second signal 535 using the antenna 560. For example, in some cases, the microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to the RFID reader 510. The RFID reader 510 may receive the second signal 535 from the RFID tag 550 via antenna 520 and may process (e.g., demodulate) the received signal to obtain the information of the data storage element 570 sent in the second signal 535.

In some cases, the RFID system 500 may be designed to operate at 13.56 MHz or some other frequency (e.g., an ultra-high frequency (UHF) band at 900 MHz). The RFID reader 510 may have a specified maximum transmit power level, which may be imposed by the Federal Communication Commission (FCC) in the United Stated or other regulatory bodies in other countries. The specified maximum transmit power level of the RFID reader 510 may limit the distance at which RFID tag 550 can be read by RFID reader 510.

FIG. 5B illustrates an example equivalent circuit 553 of the antenna 560 of and an example topography of the energy harvesting circuitry 555 of the RFID tag 550. In some cases, as illustrated in the equivalent circuit 553 of the antenna 560, a lossless antenna may be modelled as an alternating current (AC) voltage source (vₛ(t)) followed by a series antenna resistance (Rₐₙₜ) of the antenna 560. In some cases, the voltage source (vₛ(t)) may be based on an energy signal y_{rf}(t)) received from the RFID reader 510. The equivalent circuit 553 of the antenna 560 also includes an input resistance (Rᵢₙ) representing a resistance associated with the energy harvesting circuitry 555. In some cases, with perfect impedance matching, Rᵢₙ may equal Rₐₙₜ.

As shown, the energy harvesting circuitry 555 comprises a half-wave rectifier circuit configured to convert an AC input power (vᵢₙ) (e.g., received via the antenna 560) into a direct current (DC) output power (vₒᵤₜ). Further, as shown, the energy harvesting circuitry 555 comprises a diode, a capacitor (C), and a load impedance (R_{L}). The diode is configured to pass only one half of each complete sine wave of the AC voltage in order to convert it into the DC voltage. Further, as illustrated in the energy harvesting circuitry 555 in FIG. 5B, i_{d} is a current of the diode and v_{d} is a voltage of the diode. In some cases, under perfect matching, vᵢₙ(t) may be half of vₛ(t) and both can be related to the received signal energy signal (y_{rf}(t)) at the energy harvesting circuitry 555 as

$${v}_{s} ( t ) = 2 {y}_{rf} ( t ) {R}_{a n t}^{\frac{1}{2}} and {v}_{i n} ( t ) = {y}_{rf} ( t ) {R}_{a n t}^{\frac{1}{2}} .$$

### Aspects Related to Energy Signal Generation and Interference Cancelation

Wireless technology is increasingly useful in industrial applications, such as ultra-reliable low-latency communication (URLLC) and machine type communication (MTC). In such domains, and others, it is desirable to support devices that are capable of harvesting energy from alternative energy sources (e.g., in lieu of or in combination with a battery or other energy storage device, such as a capacitor). For example, in some cases, these devices may not include a local power storage component and may instead harvest energy from things such as RF signals, thermal energy, solar energy, etc.

When RF signals are used, a first device (e.g., BS 102, a disaggregated BS as described with respect to FIG. 2, UE 104, or any other device described herein capable of transmitting wireless signals), may transmit an energy signal to a second device. The second device may then harvest energy from the energy signal (e.g., using energy harvesting circuitry) and use this harvested energy to power one or more other components of the second device. In some cases, a portion of the harvested energy may be used to charge a local energy storage device of the second device for later use (i.e., the harvested energy may be stored in the local power storage component).

Different types of energy signals may be used, each of which may provide different energy harvesting/charging performance. For example, in some cases, a continuous, single-tone waveform (e.g., a sinusoidal waveform) may be used for the energy signal. In other cases, multi-tone waveforms, such as orthogonal frequency division multiplexing (OFDM) waveforms, may be used for the energy signal. In some cases, while both types of waveforms are capable of providing power that may be harvested, multi-tone waveforms may provide better RF charging/energy harvesting due to an increased number of energy bursts as compared to continuous, single-tone waveforms. The increased number of energy bursts allow diodes in energy harvesting circuitry to more easily turn on and increases the sensitivity of rectifying circuits in a low-power regime. As such, the increased number of energy bursts of the multi-tone waveforms may result in higher second and higher order (moment) statistics for the received energy signal, such as [symbol] [y_{rf}(t)⁴] in the equation:

vₒᵤₜ≈f_{EH}(y_{rf}(t))=β₂ [symbol] [y_{rf}(t)²]+β₄ [symbol] [y_{rf}(t)⁴],

where vₒᵤₜ represents the output direct current (DC) voltage (after RF to DC conversion), f_{EH} is a function that maps an input signal to the output DC voltage,

$${β}_{j = \frac{{i}_{s}}{j ! {( {nv}_{t} )}^{j}}} ( j ∈ n$$

{2,4}) is a constant that depends on a reverse bias saturation current iₛ of the diode, vₜ is the thermal voltage, n is the ideality factor (assumed equal to 1.05), y_{rf}(t) is the received energy signal at the energy harvesting circuitry of the second device (e.g., energy harvesting circuitry 555 illustrated in FIGS. 5A and 5B). This observation may also valid for modulation and input distributions with large higher moments, so as to boost [symbol] [y_{rf}(t)⁴]. This can be the case with multi-tone signal where the increased number of tones can boost energy due to increased [symbol] [y_{rf}(t)⁴]. In addition, with using certain complex sequences that have high [symbol] [y_{rf}(t)⁴]. Note that the expression above was truncated to keep only the 2^{nd} and 4^{th} order of y_{rf}(t) as an approximation.

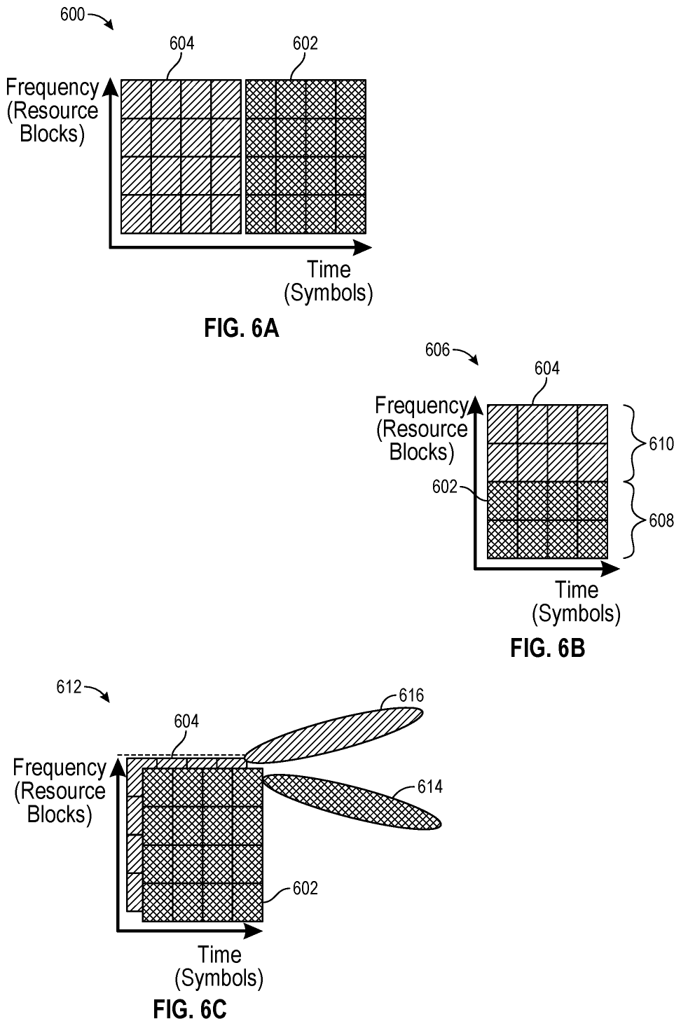

In some cases, it may be possible to multiplex energy signals with data signals. Multiplexing the energy signals and the data signals may provide more efficient use of time-frequency resources within a wireless network as well as allowing an energy harvesting device, such as the second device described above, to be powered on via the energy signal and able to receive the data signals. FIGS. 6A, 6B, and 6C illustrate different methods for multiplexing energy signals and data signals. In some cases, the multiplexed energy signals and data signals may be intended for one UE or different UEs.

For example, FIG. 6A shows a time-frequency resource grid 600 illustrating time division multiplexing (TDM) of an energy signal 602 with a data signal 604. TDM involves transmitting different signals at different times, in some cases using the same frequency resources. For example, as shown, the data signal 604 is transmitted first followed by the energy signal 602. As such, the energy signal 602 and data signal 604 may be transmitted using same frequency resources but at different times.

FIG. 6B shows a time-frequency resource grid 606 illustrating frequency division multiplexing (FDM) of the energy signal 602 with the data signal 604. FDM involves transmitting different signals during at least a partially overlapping time period (e.g., a number of symbols) but using different frequencies. For example, as shown, the energy signal 602 is transmitted using a first frequency band 608 and the data signal 604 is transmitted using a second frequency band 610. Because the energy signal 602 and the data signal 604 are transmitted using separate frequency bands, these signals may be transmitted during an overlapping time period (e.g., in this example, four symbols).

FIG. 6C shows a time-frequency resource grid 612 illustrating spatial division multiplexing (SDM) of the energy signal 602 with the data signal 604. SDM involves transmitting different signals using the same time-frequency resources but in different spatial directions. For example, as shown, the energy signal 602 and the data signal 604 are transmitted using the same time-frequency resources. However, in some cases, the energy signal 602 may be transmitted (e.g., to a first UE) in a first spatial direction using a first transmission beam 614 while the data signal 604 may be transmitted (e.g., to a second UE) in a second spatial direction (different from the first spatial direction) using a second transmission beam 616. In some cases, when using SDM, the energy signal 602 and the data signal 604 may be transmitted using the same antenna ports or different antenna ports. In some cases, if the energy signal 602 and the data signal 604 are transmitted on a same antenna port, the demodulation reference signals (DMRSs) of the energy signal 602 and the data signal 604 may be separated from each other using cyclic shifts.

While the multiplexing of signals is generally designed to reduce interference between differing signals, such as between energy signals and data signals, there may be instances in which energy signals from a first device to a second device may cause interference to data signals transmitted a third device (or even to data signals transmitted to the second device). This interference may negatively affect an ability of the third device to properly receive and decode the data signals, leading, in some cases, to retransmissions of the data signals due to improperly received original transmissions of the data signals. These retransmissions unnecessarily consume time-frequency resources within a wireless communication network as well as power resources at both the first device and second device. Moreover, these retransmissions increase latency of reception of the data signals, leading to poor user experience.

Accordingly, aspects of the present disclosure provide techniques for reducing interference caused by the transmission of energy signals within a wireless communication network for powering certain wireless communication devices. In some cases, for example, these techniques may include a first UE (e.g., energy harvesting capable receive device) transmitting, to a network entity, a preferred configuration for transmitting an energy signal to power one or more components of the first UE. In some cases, the preferred configuration may indicate a set of parameters, such as multiplexing type for the energy signal with data, a waveform type for the energy signal, or a modulation type for the energy signal. The network entity may select a configuration for the energy signal based, at least in part, on the preferred configuration (and, in some cases, other criteria described below) and may transmit an indication of the selected configuration to the first UE and a second UE.

In some cases, the second UE may perform an interference cancellation procedure based on the selected configuration of the energy signal to remove interference caused by the energy signal to one or more data signals received by the second UE. In other words, as noted above, the techniques described herein for selecting and indicating the configuration for the energy signal may allow devices, such as the first UE and second UE, to effectively cancel interference caused by an energy signal, which in-turn improves the probability that data signals are properly received and decoded by the devices. Moreover, because interference caused by the energy signal may be more effectively canceled according to aspects described herein, the number of the number of retransmissions of these the data signals may be reduced, thereby conserving time-frequency resources within the wireless communication network and conserving power resources among the devices communicating in the wireless communications network.

### Example Operations of Entities in a Communications Network

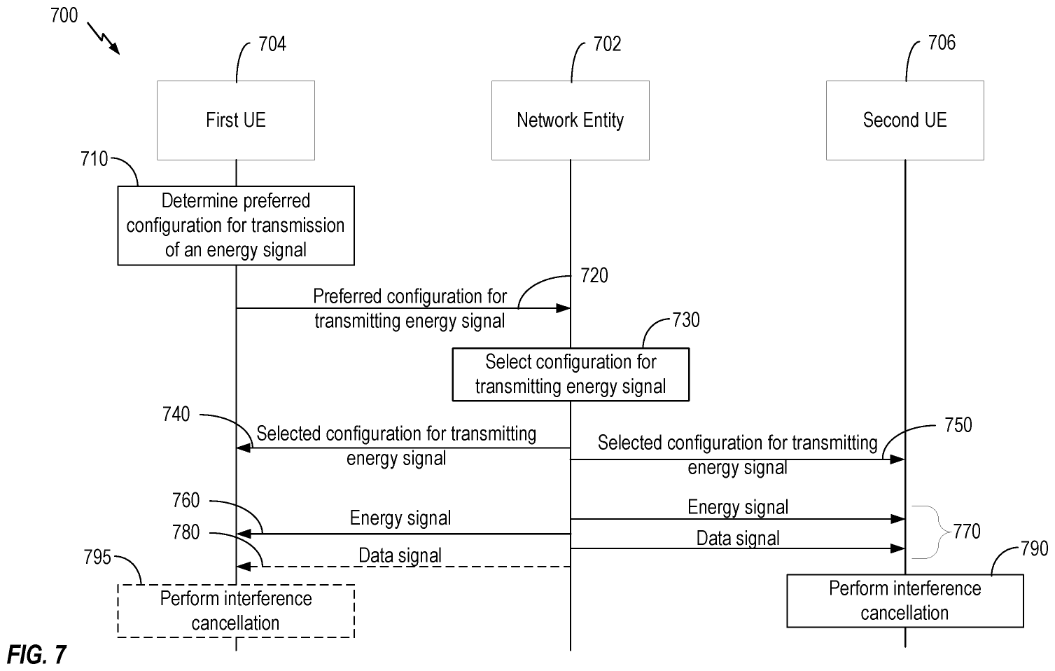

FIG. 7 depicts example operations 700 for communications in a network between a network entity 702, a first UE 704, and second UE 706 in a wireless communications network. In some aspects, the network entity 702 may be an example of the BS 102 depicted and described with respect to FIGS. 1 and 3, a disaggregated base station depicted and described with respect to FIG. 2, or the UE 104 depicted and described with respect to FIGS. 1 and 3. In some cases, the network entity 702 may be capable of transmitting energy signals for powering one or more other devices, such as the first UE 704 and/or second UE 706.

In some cases, the first UE 704 may be capable of harvesting energy from energy signals transmitted by the network entity 702. In some cases, the first UE 704 may be an example of UE 104 depicted and described with respect to FIGS. 1 and 3. In some cases, the first UE 704 may be another type of device, such as a repeater or a reduced capability (RedCap) device. In some cases, the first UE 704 may comprise a semi-passive or semi-active low-power communication device (e.g., having a few active components such as a power amplifier), an active communication device (e.g., a normal, high-complexity UE), a PIoT device, or a backscattering-based communication device such as an RFID device (e.g., tag). In some cases, the second UE 706 may be another example of UE 104 depicted and described with respect to FIGS. 1 and 3. In some cases, the second UE 706 may be capable of receiving data signals from the network entity and may or may not be capable of harvesting energy from the energy signals transmitted by the network entity 702.

As shown, operations 700 begin in step 710 with the first UE 704 determining a preferred configuration for transmitting (e.g., by the network entity 702) an energy signal to power one or more components of the first UE 704. In some cases, the first UE 704 may determine the preferred configuration based on certain criteria, such as a charging rate associated with the first UE 704, channel conditions associated with a channel for transmitting the energy signal, a frequency range for transmitting the energy signal, a data rate associated with data signals transmitted to the first UE 704, and/or a block error ratio (BLER) associated with data signals transmitted to the first UE 704. In some cases, if data signals are transmitted to the first UE 704, the preferred configuration may also be based on a particular waveform type used for transmitting the data signals.

Thereafter, in step 720 of FIG. 7, the first UE 704 transmits, to the network entity 702, an indication of the preferred configuration for transmitting the energy signal to power the one or more components of the first UE 704. In some cases, the indication of the preferred configuration for transmitting the energy signal includes a set of parameters. The set of parameters may indicate at least one of a multiplexing type for the energy signal with data, a waveform type for the energy signal, or a modulation type for the energy signal. In some cases, the multiplexing type for the energy signal with data, the waveform type for the energy signal, and the modulation type for the energy signal included within the set of parameters may be based on the criteria described above, such as the charging rate associated with the first UE 704, the channel conditions associated with the channel for transmitting the energy signal, the frequency range for transmitting the energy signal, and the like.

In some cases, the multiplexing type for multiplexing the energy signal with data may include, for example, TDM, FDM, or SDM, as described above with respect to FIGS. 6A-6C.

In some cases, the modulation type for the energy signal may include a reference signal (RS)-based modulation type, a circularly symmetric complex Gaussian (CSCG) modulation type, an improper complex Gaussian modulation type, an optimized sequence-based modulation type, an amplitude shift keying (ASK)-based modulation type, a phase shift keying (PSK)-based modulation type, a frequency shift keying (FSK) modulation type, a pulse position modulation (PPM)-based modulation type, a quadrature amplitude modulation (QAM)-based modulation type, an on-off keying (OOK)-based modulation type, a Zadoff Chu-based modulation type, a Bernoulli sequence-based modulation type, or a modulation type based on a known seed or scrambling identifier (ID). In some cases, the modulation type for the energy signal may include an optimized-sequence-based modulation type generated at the network entity 702. In some cases, the optimized sequence may be a sequence without a certain structure or a known code that was found by the network entity 702 or first UE 704 during optimization for a given set of parameters that provides the best performance under certain constraints. In some cases, the network entity 702 may transmit a message indicating the optimized sequence to any wireless communication devices that may need to cancel the energy signal prior to decoding data, such as the second UE 706 and/or the first UE 704.

In some cases, these different types of waveforms may each impact a charging rate associated energy harvesting circuitry of the first UE 704 differently. Accordingly, in some cases, the first UE 704 may select the waveform type to be included within the set of parameters associated with the preferred configuration based on a desired or required charging rate for the energy harvesting circuitry of the first UE 704.

In some cases, the waveform type for the energy signal may comprise at least one of a single tone continuous wave waveform type, a multi-tone continuous wave waveform type, a cyclic prefix—orthogonal frequency division multiplexing (CP-OFDM) waveform type, a single carrier quadrature amplitude modulation (SC-QAM) waveform type, or a discrete Fourier transform-spread orthogonal frequency-division multiplexing (DFT-s-OFDM) waveform type. In some cases, for high frequency bands, the network entity 702 may be expected to support SC waveforms. As such, if the energy signal is expected to be transmitted at a higher frequency, the waveform type included within the set of parameters may indicate, for example, SC-QAM or some other SC waveform type.

In some cases, the indication of the preferred configuration transmitted to the network entity 702 may comprise an index value that corresponds to one of a plurality of configurations. For example, in some cases, an index value of 0 (zero) may correspond with a configuration that comprises a multiplexing type of SDM, a modulation type comprising a sequence based on a scrambling ID with contents as OOK symbols, and a waveform type of CP-OFDM. In some cases, an index value of 1 (one) may correspond with a configuration that comprises a multiplexing type of TDM, a modulation type comprising a sequence based on a scrambling ID with contents as QAM symbols, and a waveform type of CP-OFDM. In some cases, the network entity 702 may use the index value and a look up table (e.g., that maps index values and configurations), for example, to determine the preferred configuration for transmitting the energy signal.

The first UE 704 may transmit the indication the indication of the preferred configuration to the network entity 702 in different manners. For example, in some cases, the first UE 704 may transmit the indication of the preferred configuration to the network entity 702 in a radio resource control (RRC) message (e.g., as part of user assistance information), a media access control—control element (MAC-CE) message, or a physical uplink control channel (PUCCH) message or physical uplink shared channel (PUSCH) message. In some cases, indication of the preferred configuration may be transmitted to the network entity 702 in a sidelink message, such as a sidelink MAC-CE, a sidelink RRC message, physical sidelink shared channel (PSSCH), a physical sidelink control channel (PSCCH), and/or a physical sidelink feedback channel (PSFCH).

After the first UE 704 transmits the indication of a preferred configuration to the network entity 702 in step 720, the network entity 702 selects, in step 730 of FIG. 7, a configuration for transmitting the energy signal to the first UE 704 based, at least in part, on the preferred configuration received from the first UE. In other words, the network entity 702 may take into account the preferred configuration received from the first UE 704 when selecting the (actual, to be used) configuration for transmitting the energy signal.

In some cases, in addition to the preferred configuration received from the first UE 704, the network entity 702 may select the configuration for transmitting the energy signal based on at least one of a charging rate associated with the first UE, channel conditions associated with a channel for transmitting the energy signal, a BLER associated data transmissions to at least one of the second UE 706 or the first UE 704, a data rate associated with transmissions to at least one of the second UE 706 or the first UE 704, and/or a frequency range for transmitting the energy signal. In some cases, the network entity 702 may also select the configuration for transmitting the energy signal based on a waveform of the data transmissions to at least one of the first UE 704 or second UE 706.

Thereafter, as illustrated at steps 740 and 750 in FIG. 7, the network entity 702 respectively transmits an indication of selected configuration to the first UE 704 and the second UE 706 including a set of parameters associated with the energy signal. In some cases, the indication of selected configuration may be transmitted to the first UE 704 and the second UE 706 in at least one of downlink control information (DCI), sidelink control information (SCI), a sidelink RRC message, or a sidelink MAC-CE message, Uu-interface MAC-CE, or a Uu-interface RRC.

As described above, the set of parameters may include a configuration index indicating the selected configuration among a plurality of configurations for transmitting the energy signal. Further, the set of parameters of the selected configuration may include at least one of the multiplexing type of the energy signal, the waveform type of the energy signal, or the modulation type of the energy signal.

In some cases, the set of parameters indicates a seed or scrambling ID used in generating the energy signal. For example, in some cases, the energy signal may comprise a particular sequence (e.g., a sequence with complex values, including a Zadoff-Chu-based sequence, OOK-based sequence, a pulse-amplitude modulation (PAM)-based sequence, etc.) that is generated based on the seed or scrambling ID. Accordingly, to allow the second UE 706 (and, in some cases the first UE 704) to perform interference cancellation, as will be described in more detail below, the set of parameters may indicate the seed or scramble ID used to generate the energy signal seed. The second UE 706 (and, in some cases, the first UE 704) may use the seed or scrambling ID to locally generate the energy signal sequence in order to remove it (thereby mitigating any interference caused by the energy signal) from transmissions from the network entity 702 that include data signals. In such cases, the seed or scrambling ID included in the set of parameters may be transmitted in a MAC-CE message or an RRC message. In some cases, if the energy signal sequence is deterministically generated, the seed or scrambling ID may not need to be indicated.

In some cases, a set of energy signal sequences may be defined for the energy signal and indicated to at least one of the first UE 704 or second UE 706 in an RRC message or MAC-CE message transmitted by the network entity 702. In such cases, in order to indicate the sequence of the energy signal, the set of parameters included within the selected configuration may include an indication of an energy signal sequence selected from the set of energy signal sequences. In some cases, the indication of the energy signal sequence selected from the set of energy signal sequences may be transmitted by the network entity 702 in DCI.

In some cases, the set of parameters may include a demodulation reference signal (DMRS) configuration. The DMRS configuration may indicate resources associated with the energy signal used for transmitting one or more DMRSs. Additionally, in some cases, the DMRS configuration may further indicate at least one of a scrambling ID associated with the one or more DMRSs or a port number associated with the one or more DMRSs. In some cases, the DMRS configuration may allow the second UE 706 (and, in some cases the first UE 704) to estimate, during reception of data signals, a precoded channel between the network entity 702 and the second UE 706 (or first UE 704) so that interference caused by the energy signal may be canceled/mitigated. In some cases, the one or more DMRSs associated with the energy signal may have different port numbers from one or more DMRSs associated with data signals transmitted by the network entity 702. For example, the port numbers for the one or more DMRSs associated with the energy signal may be separated from the port numbers for the one or more DMRSs associated with the data signals using time/frequency orthogonal cover codes.

In some cases, the one or more DMRSs associated with the energy signal may be configured in the DMRS configuration and conveyed via an RRC message or MAC-CE message. In some cases, the scrambling ID and port numbers of the one or more DMRS may be indicated in DCI. In other words, a portion of the DMRS configuration may be conveyed via RRC/MAC-CE while a remaining portion of the DMRS configuration may be conveyed via DCI. In other cases, the DMRS configuration may be fully transmitted via RRC or MAC-CE.

After the network entity 702 transmits the indication of the selected configuration to the first UE 704 and the second UE 706, the network entity 702 transmits the energy signal based, at least in part, on the selected configuration (which may also be based, at least in part, on the preferred configuration received from the first UE 704). In some cases, the network entity 702 may apply a particular precoder to the energy signal in order to beamform the energy signal in a direction of the first UE 704. However, while the energy signal may be transmitted in the direction of the first UE 704, there may be instances in which the energy signal may also be received by the second UE 706. For example, as shown in FIG. 7, the energy signal may be received by the first UE 704 in step 760 and may also be received by the second UE 706 in step 770. In some cases, the first UE 704 may harvest energy from the energy signal to power the one or more components of the first UE. In some cases, the first UE 704 may store a portion of the harvested energy from the energy signal in an energy storage device of the first UE

Further, as shown in step 770, in addition to receiving the energy signal, the second UE 706 may also receive one or more data signals from the network entity 702. In some cases, if the first UE 704 is capable, the first UE 704 may also optionally receive one or more data signals from the network entity 702, as shown in step 780.

In some cases, the energy signal may cause interference to the one or more data signals transmitted to the second UE 706 in step 760. To help mitigate the effects of the interference caused by the energy signal, the second UE 706 performs an interference cancellation procedure based on the selected configuration of the energy signal to remove interference caused by the energy signal to the one or more data signals. In some cases, this interference cancellation procedure may be known as energy-interference-cancellation (EIC). In some cases, performing the interference cancellation procedure may include locally generating an expected sequence of the energy signal using the selected configuration. The second UE 706 may then subtract the expected sequence of the energy signal from a combined transmission (e.g., received in step 760) received from the network entity 702 that includes the energy signal and the one or more data signals.

In some cases, as noted above, the first UE 704 may also optionally receive one or more data signals from the network entity 702, as shown in step 780. In such cases, the first UE 704 may also optionally perform, as shown at 795, an interference cancellation procedure based on the selected configuration of the energy signal to remove interference caused by the energy signal to the one or more data signals.

Additionally, in some cases, if the one or more data signals and the energy signal are beamformed using a same precoder to the first UE 704, the first UE 704 may use the energy signal to perform channel estimation for the one or more data signals (e.g., since the energy signal is generated with a known sequence). In other words, in some cases, the energy signal and one or more data signals received by the first UE 704 in steps 770 and 780 may be beamformed using same precoder. In such cases, the first UE 704 may use the energy signal to perform channel estimation associated with the one or more data signals, which may help the first UE 704 when performing the interference cancellation procedure in step 795 and may also help when attempting to decode the one or more data signals after the interference procedure has been performed.

In some cases, the selected configuration for the energy signal may change over time, for example, based on changing channel conditions, charging rate requirements, etc. In such cases, the network entity 702 may transmit an indication of an updated configuration for the energy signal in DCI or SCI. Further, when an updated configuration is receive, the second UE 706 and the first UE 704 may perform the interference cancellation procedures in steps 790 and 795, respectively, based on the updated configuration.

### Example Operations of a First User Equipment

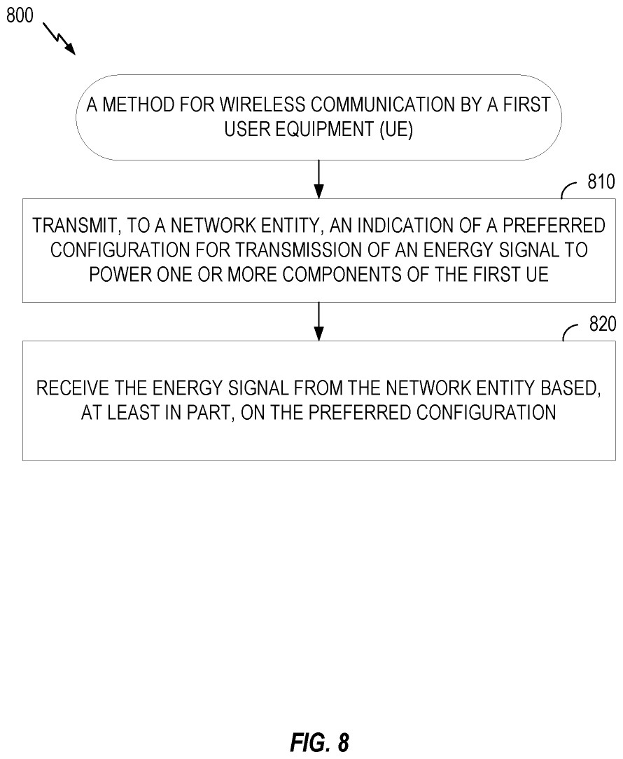

FIG. 8 shows a method 800 for wireless communications by a first UE, such as UE 104 of FIGS. 1 and 3, the first UE 704 described with respect to FIG. 7, or the RFID tag 550 described with respect to FIG. 5A.

Method 800 begins at 810 with transmitting, to a network entity, an indication of a preferred configuration for transmission of an energy signal to power one or more components of the first UE.

Method 800 then proceeds to step 820 with receiving the energy signal from the network entity based, at least in part, on the preferred configuration.

In some cases, method 800 may further include harvesting energy from the energy signal to power the one or more components of the first UE.

In some cases, method 800 may further include storing a portion of the harvested energy from the energy signal in a power storage component of the first UE.

In some cases, the preferred configuration comprises a set of parameters indicating at least one of: a multiplexing type for the energy signal with data, a waveform type for the energy signal, or a modulation type for the energy signal.

In some cases, the modulation type for the energy signal comprises one of: a reference signal (RS)-based modulation type, a circularly symmetric complex Gaussian (CSCG) modulation type, an improper complex Gaussian modulation type, an optimized sequence-based modulation type, an amplitude shift keying (ASK)-based modulation type, a phase shift keying (PSK)-based modulation type, a frequency shift keying (FSK) modulation type, a pulse position modulation (PPM)-based modulation type, a quadrature amplitude modulation (QAM)-based modulation type, an on-off keying (OOK)-based modulation type, a Zadoff Chu-based modulation type, a Bernoulli sequence-based modulation type, or a modulation type based on a known seed or scrambling ID.

In some cases, the waveform type for the energy signal comprises one of: wherein the waveform type for the energy signal comprises one of: a single tone continuous wave waveform type, a multi-tone continuous wave waveform type, a CP-OFDM waveform type, an SC-QAM waveform type, or a DFT-s-OFDM waveform type.

In some cases, method 800 may further include determining the preferred configuration for transmitting an energy signal based on at least one of: a charging rate associated with the first UE, channel conditions associated with a channel for transmitting the energy signal, or a frequency range for transmitting the energy signal.

In some cases, transmitting the indication of the preferred configuration to the network entity in step 810 comprises transmitting the indication of the preferred configuration to the network entity in at least one of: a RRC message, a MAC-CE message, a sidelink message, or a PUCCH message or PUSCH message.

In some cases, method 800 may further include receiving an indication of a selected configuration for the energy signal from the network entity, wherein: the selected configuration for the energy signal is based, at least in part, on the preferred configuration transmitted to the network entity, and receiving the energy signal from the network entity is further based on the selected configuration.

In some cases, method 800 may further include receiving one or more data signals and performing an interference cancellation procedure based on the selected configuration for the energy signal to remove interference caused by the energy signal to the one or more data signals.

In some cases, the indication of the selected configuration is received in a radio resource control (RRC) message or a MAC-CE message.

In some cases, method 800 may further include receiving an indication of an updated configuration for the energy signal in DCI or SCI, wherein receiving the energy signal is further based on the updated configuration.

In some cases, the first UE comprises one of: a semi-passive or semi-active low-power communication device, an active communication device, a PIoT device, or a backscattering-based communication device.

In some cases, the energy signal and one or more data signals are beamformed using same precoder; and the method 800 further includes using the energy signal to perform channel estimation associated with the one or more data signals.

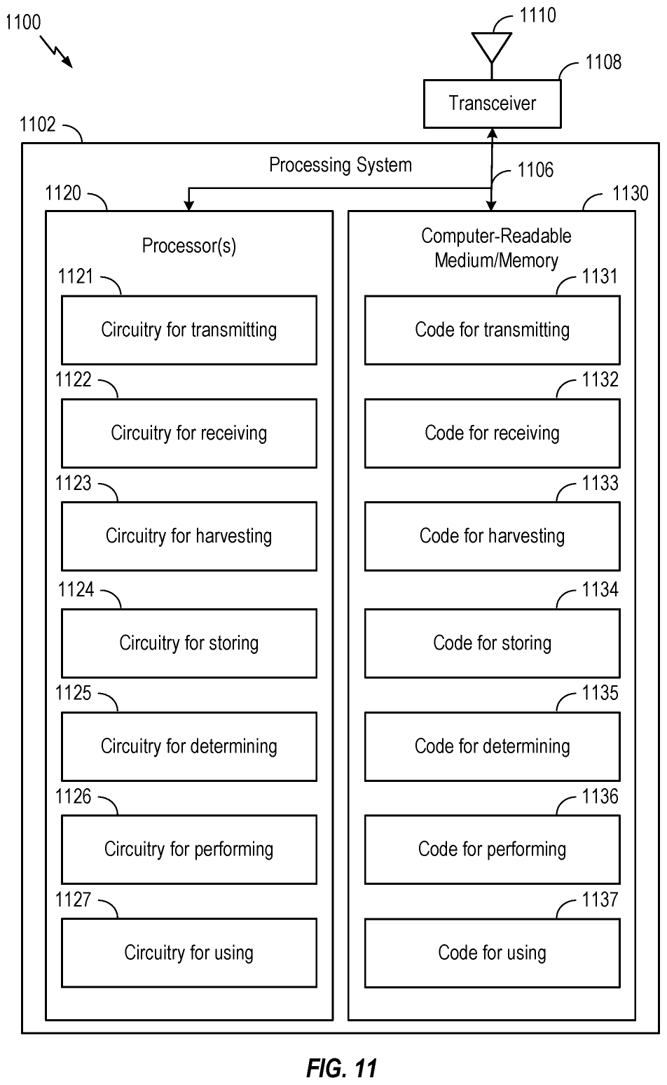

In one aspect, method 800, or any aspect related to it, may be performed by an apparatus, such as communications device 1100 of FIG. 11, which includes various components operable, configured, or adapted to perform the method 800. Communications device 1100 is described below in further detail.

Note that FIG. 8 is just one example of a method, and other methods including fewer, additional, or alternative steps are possible consistent with this disclosure.

### Example Operations of a Second User Equipment

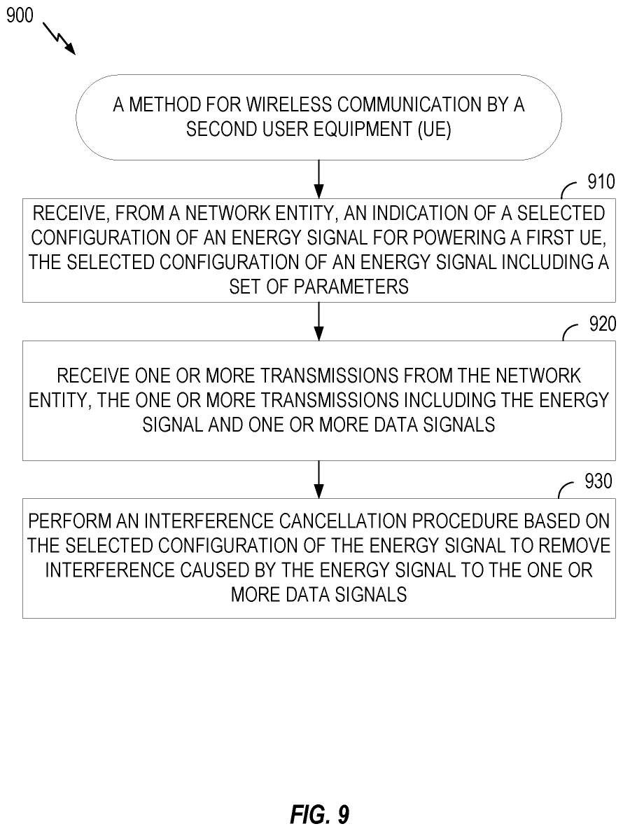

FIG. 9 shows a method 900 for wireless communications by a second UE, such as UE 104 of FIGS. 1 and 3 or the second UE 706 described with respect to FIG. 7

Method 900 begins at 910 with receiving, from a network entity, an indication of a selected configuration of an energy signal for powering a first UE, the selected configuration of an energy signal including a set of parameters.

Method 900 then proceeds to step 920 with receiving one or more transmissions from the network entity, the one or more transmissions including the energy signal and one or more data signals.

Method 900 then proceeds to step 930 with performing an interference cancellation procedure based on the selected configuration of the energy signal to remove interference caused by the energy signal to the one or more data signals.

In some cases, the set of parameters include a configuration index indicating the selected configuration among a plurality of configurations for transmitting the energy signal.

In some cases, the set of parameters indicate at least one of: a multiplexing type of the energy signal, a type of waveform of the energy signal, or a modulation type of the energy signal.

In some cases, the modulation type for the energy signal comprises one of: a reference signal (RS)-based modulation type, a circularly symmetric complex Gaussian (CSCG) modulation type, an improper complex Gaussian modulation type, an optimized sequence-based modulation type, an amplitude shift keying (ASK)-based modulation type, a phase shift keying (PSK)-based modulation type, a frequency shift keying (FSK) modulation type, a pulse position modulation (PPM)-based modulation type, a quadrature amplitude modulation (QAM)-based modulation type, an on-off keying (OOK)-based modulation type, a Zadoff Chu-based modulation type, a Bernoulli sequence-based modulation type, or a modulation type based on a known seed or scrambling ID.

In some cases, the waveform type for the energy signal comprises one of: wherein the waveform type for the energy signal comprises one of: a single tone continuous wave waveform type, a multi-tone continuous wave waveform type, a CP-OFDM waveform type, an SC-QAM waveform type, or a DFT-s-OFDM waveform type.

In some cases, the set of parameters indicates a seed or scrambling ID used in generating the energy signal. In some cases, the seed or scrambling ID included in the set of parameters is received in a MAC-CE message.

In some cases, method 900 further includes receiving, from the network entity, a set of energy signal sequences in an RRC or a MAC-CE message. In some cases, the indication of the selected configuration is received in DCI and includes an indication of an energy signal sequence selected from the set of energy signal sequences.

In some cases, the set of parameters include a DMRS configuration, indicating resources associated with the energy signal used for transmitting one or more DMRSs.

In some cases, the DMRS configuration further indicates at least one of a scrambling ID associated with the one or more DMRSs or a port number associated with the one or more DMRSs

In some cases, the energy signal and the one or more data signals are beamformed using same precoder. In some cases, method 900 further includes using the energy signal to perform channel estimation associated with the one or more data signals.

In some cases, the indication of the selected configuration is received in a RRC message or a MAC-CE message.

In some cases, method 900 further includes receiving an indication of an updated configuration for the energy signal in DCI or SCI. In such cases, performing the interference cancellation procedure in step 930 is further based on the updated configuration.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

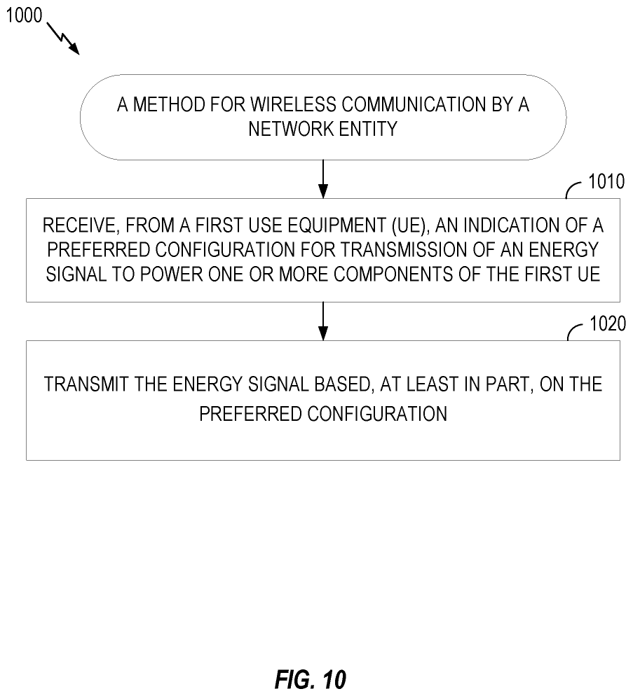

FIG. 10 shows a method 1000 for wireless communications by a network entity, such as BS 102 of FIGS. 1 and 3, or a disaggregated base station as discussed with respect to FIG. 2.

Method 1000 begins at 1010 with receiving, from a first use equipment (UE), an indication of a preferred configuration for transmission of an energy signal to power one or more components of the first UE.

Method 1000 then proceeds to step 1020 transmitting the energy signal based, at least in part, on the preferred configuration.

In some cases, the preferred configuration comprises a set of parameters indicating at least one of: a multiplexing type for the energy signal with data, a waveform type for the energy signal, or a modulation type for the energy signal.

In some cases, the modulation type for the energy signal comprises one of: a reference signal (RS)-based modulation type, a circularly symmetric complex Gaussian (CSCG) modulation type, an improper complex Gaussian modulation type, an optimized sequence-based modulation type, an amplitude shift keying (ASK)-based modulation type, a phase shift keying (PSK)-based modulation type, a frequency shift keying (FSK) modulation type, a pulse position modulation (PPM)-based modulation type, a quadrature amplitude modulation (QAM)-based modulation type, an on-off keying (OOK)-based modulation type, a Zadoff Chu-based modulation type, a Bernoulli sequence-based modulation type, or a modulation type based on a known seed or scrambling ID.

In some cases, the waveform type for the energy signal comprises one of: wherein the waveform type for the energy signal comprises one of: a single tone continuous wave waveform type, a multi-tone continuous wave waveform type, a CP-OFDM waveform type, an SC-QAM waveform type, or a DFT-s-OFDM waveform type.

In some cases, the preferred configuration for transmitting an energy signal based on at least one of: a charging rate associated with the UE, channel conditions associated with a channel for transmitting the energy signal, or a frequency range for transmitting the energy signal.

In some cases, receiving the indication of the preferred configuration from the first UE in step 1010 comprises receiving the indication of the preferred configuration from the first UE in at least one of: an RRC message, a MAC-CE message, a sidelink message, a PUCCH message or PUSCH message.

In some cases, method 1000 further includes selecting a configuration for transmitting the energy signal to the first UE based, at least in part, on the preferred configuration received from the first UE.

In some cases, selecting the configuration for transmitting the energy signal to the first UE is based further on at least one of: a charging rate associated with the first UE, channel conditions associated with a channel for transmitting the energy signal, a BLER associated data transmissions to a second UE, a data rate associated with transmissions to a second UE, or a frequency range for transmitting the energy signal.

In some cases, method 1000 further includes transmitting an indication of selected configuration to the first UE and a second UE including a set of parameters associated with the energy signal.

In some cases, the set of parameters include a configuration index indicating the selected configuration among a plurality of configurations for transmitting the energy signal.

In some cases, the set of parameters indicate at least one of: a multiplexing type of the energy signal, a type of waveform of the energy signal, or a modulation type of the energy signal.

In some cases, the modulation type for the energy signal comprises one of: a reference signal (RS)-based modulation type, a circularly symmetric complex Gaussian (CSCG) modulation type, an improper complex Gaussian modulation type, an optimized sequence-based modulation type, an amplitude shift keying (ASK)-based modulation type, a phase shift keying (PSK)-based modulation type, a frequency shift keying (FSK) modulation type, a pulse position modulation (PPM)-based modulation type, a quadrature amplitude modulation (QAM)-based modulation type, an on-off keying (OOK)-based modulation type, a Zadoff Chu-based modulation type, a Bernoulli sequence-based modulation type, or a modulation type based on a known seed or scrambling ID.

In some cases, the waveform type for the energy signal comprises one of: wherein the waveform type for the energy signal comprises one of: a single tone continuous wave waveform type, a multi-tone continuous wave waveform type, a CP-OFDM waveform type, an SC-QAM waveform type, or a DFT-s-OFDM waveform type.

In some cases, the set of parameters indicates a seed or scrambling ID used in generating the energy signal. In some cases, the seed or scrambling ID included in the set of parameters is transmitted in a MAC-CE message.

In some cases, method 1000 further includes transmitting a set of energy signal sequences in an RRC or a MAC-CE message to the second UE. In some cases, the indication of the selected configuration is transmitted in DCI and includes an indication of an energy signal sequence selected from the set of energy signal sequences.

In some cases, the set of parameters include a DMRS configuration, indicating resources associated with the energy signal used for transmitting one or more DMRSs.

In some cases, the DMRS configuration further indicates at least one of a scrambling ID associated with the one or more DMRSs or a port number associated with the one or more DMRSs.

In some cases, the indication of the selected configuration is transmitted in an RRC message or a MAC-CE message.

In some cases, method 1000 further includes transmitting an indication of an updated configuration for the energy signal in DCI or SCI, wherein transmitting the energy signal is further based on the updated configuration.

In one aspect, method 1000, or any aspect related to it, may be performed by an apparatus, such as communications device 1200 of FIG. 14, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3. In some cases, the communications device 1100 may be an example of the first UE 704 described with respect to FIG. 7. In other cases, the communications device 1100 may be an example of the second UE 706 described with respect to FIG. 7

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 800 described with respect to FIG. 8 and/or the method 900 described with respect to FIG. 9, or any aspect related to them. Note that reference to a processor performing a function of communications device 1100 may include one or more processors performing that function of communications device 1100.

In the depicted example, computer-readable medium/memory 1130 stores code (e.g., executable instructions) for transmitting 1131, code for receiving 1132, code for harvesting 1133, code for storing 1134, code for determining 1135, code for performing 1136, and code for using 1137. Processing of the code 1131-1133 may cause the communications device 1100 to perform the method 800 described with respect to FIG. 8 and/or the method 900 described with respect to FIG. 9, or any aspect related to them.

The one or more processors 1120 include circuitry configured to implement (e.g., execute) the code stored in the computer-readable medium/memory 1130, including circuitry for transmitting 1121, circuitry for receiving 1122, circuitry for harvesting 1123, circuitry for storing 1124, circuitry for determining 1125, circuitry for performing 1126, and circuitry for using 1127. Processing with circuitry 1121-1123 may cause the communications device 1100 to perform the method 800 described with respect to FIG. 8 and/or the method 900 described with respect to FIG. 9, or any aspect related to them.

Various components of the communications device 1100 may provide means for performing the method 800 described with respect to FIG. 8 and/or the method 900 described with respect to FIG. 9, or any aspect related to them. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11. Means for harvesting, means for storing, means for determining, means for using, and means for performing may comprise one or more processors, such controller/processor 380, the transmit processor 364, or the receive processor 358.

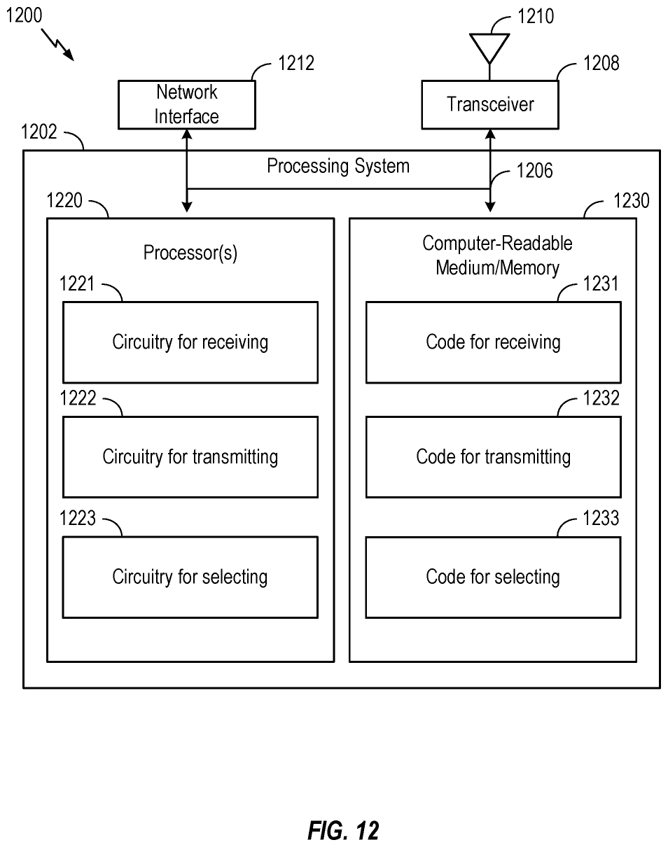

FIG. 12 depicts aspects of an example communications device. In some aspects, communications device 1200 is a network entity, such as BS 102 of FIGS. 1 and 3, or a disaggregated base station as discussed with respect to FIG. 2.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220. In various aspects, one or more processors 1220 may be representative of one or more of receive processor 338, transmit processor 320, TX MIMO processor 330, and/or controller/processor 340, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it. Note that reference to a processor of communications device 1200 performing a function may include one or more processors of communications device 1200 performing that function.

In the depicted example, the computer-readable medium/memory 1230 stores code (e.g., executable instructions) for receiving 1231, code for transmitting 1232, and code for selecting 1233. Processing of the code 1231-1232 may cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for receiving 1231, circuitry for transmitting 1222, and circuitry for selecting 1223. Processing with circuitry 1221-1222 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include the transceivers 332 and/or antenna(s) 334 of the BS 102 illustrated in FIG. 3 and/or transceiver 1208 and antenna 1210 of the communications device 1200 in FIG. 12. Means for receiving or obtaining may include the transceivers 332 and/or antenna(s) 334 of the BS 102 illustrated in FIG. 3 and/or transceiver 1208 and antenna 1210 of the communications device 1200 in FIG. 12. Means for selecting may comprise one or more processors, such as the controller/processor 340, the transmit processor 320, or the receive processor 338.

### Example Clauses

Implementation examples are described in the following numbered clauses:
Clause 1: A method for wireless communication by a first user equipment (UE), comprising: transmitting, to a network entity, an indication of a preferred configuration for transmission of an energy signal to power one or more components of the first UE; and receiving the energy signal from the network entity based, at least in part, on the preferred configuration.
Clause 2: The method of Clause 1, further comprising harvesting energy from the energy signal to power the one or more components of the first UE.
Clause 3: The method of Clause 2, further comprising storing a portion of the harvested energy from the energy signal in a power storage component of the first UE.
Clause 4: The method of any one of Clauses 1-3, wherein the preferred configuration comprises a set of parameters indicating at least one of: a multiplexing type for the energy signal with data; a waveform type for the energy signal; or a modulation type for the energy signal.
Clause 5: The method of Clause 4, wherein modulation type for the energy signal comprises one of: a reference signal (RS)-based modulation type; a circularly symmetric complex Gaussian (CSCG) modulation type; an improper complex Gaussian modulation type; an optimized sequence-based modulation type; an amplitude shift keying (ASK)-based modulation type; a phase shift keying (PSK)-based modulation type; a frequency shift keying (FSK) modulation type; a pulse position modulation (PPM)-based modulation type; a quadrature amplitude modulation (QAM)-based modulation type; an on-off keying (OOK)-based modulation type; a Zadoff Chu-based modulation type; a Bernoulli sequence-based modulation type; or a modulation type based on a known seed or scrambling identifier (ID).
Clause 6: The method of any one of Clauses 4-5, wherein the waveform type for the energy signal comprises one of: a single tone continuous wave waveform type; a multi-tone continuous wave waveform type; a cyclic prefix—orthogonal frequency division multiplexing (CP-OFDM) waveform type; a single carrier quadrature amplitude modulation (SC-QAM) waveform type; or a discrete Fourier transform-spread orthogonal frequency-division multiplexing (DFT-s-OFDM) waveform type.
Clause 7: The method of any one of Clauses 1-6, further comprising determining the preferred configuration for transmitting an energy signal based on at least one of: a charging rate associated with the first UE; channel conditions associated with a channel for transmitting the energy signal; or a frequency range for transmitting the energy signal.
Clause 8: The method of any one of Clauses 1-7, wherein transmitting the indication of the preferred configuration to the network entity comprises transmitting the indication of the preferred configuration to the network entity in at least one of: a radio resource control (RRC) message; a media access control—control element (MAC-CE) message; a sidelink message; or a physical uplink control channel (PUCCH) message or physical uplink shared channel (PUSCH) message.
Clause 9: The method of any one of Clauses 1-8, further comprising: receiving an indication of a selected configuration for the energy signal from the network entity, wherein: the selected configuration for the energy signal is based, at least in part, on the preferred configuration transmitted to the network entity, and receiving the energy signal from the network entity is further based on the selected configuration.
Clause 10: The method of Clause 9, further comprising: receiving one or more data signals; and performing an interference cancellation procedure based on the selected configuration for the energy signal to remove interference caused by the energy signal to the one or more data signals.
Clause 11: The method of any one of Clauses 9-10, wherein the indication of the selected configuration is received in a radio resource control (RRC) message or a media access control—control element (MAC-CE) message.
Clause 12: The method of Clause 11, further comprising: receiving an indication of an updated configuration for the energy signal in downlink control information (DCI) or sidelink control information (SCI), wherein receiving the energy signal is further based on the updated configuration.
Clause 13: The method of any one of Clauses 1-12, wherein the first UE comprises one of: a semi-passive or semi-active low-power communication device; an active communication device; a passive internet of things (PIoT) device; or a backscattering-based communication device.
Clause 14: The method of any one of Clauses 1-13, wherein: the energy signal and one or more data signals are beamformed using same precoder; and the method further comprises using the energy signal to perform channel estimation associated with the one or more data signals.
Clause 15: A method for wireless communication by a network entity, comprising: receiving, from a first use equipment (UE), an indication of a preferred configuration for transmission of an energy signal to power one or more components of the first UE; and transmitting the energy signal based, at least in part, on the preferred configuration.
Clause 16: The method of Clause 15, wherein the preferred configuration comprises a set of parameters indicating at least one of: a multiplexing type for the energy signal with data; a waveform type for the energy signal; or a modulation type for the energy signal.
Clause 17: The method of Clause 16, wherein modulation type for the energy signal comprises one of: a reference signal (RS)-based modulation type; a circularly symmetric complex Gaussian (CSCG) modulation type; an improper complex Gaussian modulation type; an optimized sequence-based modulation type; an amplitude shift keying (ASK)-based modulation type; a phase shift keying (PSK)-based modulation type; a frequency shift keying (FSK) modulation type; a pulse position modulation (PPM)-based modulation type; a quadrature amplitude modulation (QAM)-based modulation type; an on-off keying (OOK)-based modulation type; a Zadoff Chu-based modulation type; a Bernoulli sequence-based modulation type; or a modulation type based on a known seed or scrambling identifier (ID).
Clause 18: The method of any one of Clauses 16-17, wherein the waveform type for the energy signal comprises one of: a single tone continuous wave waveform type; a multi-tone continuous wave waveform type; a cyclic prefix—orthogonal frequency division multiplexing (CP-OFDM) waveform type; a single carrier quadrature amplitude modulation (SC-QAM) waveform type; or a discrete Fourier transform-spread orthogonal frequency-division multiplexing (DFT-s-OFDM) waveform type.
Clause 19: The method of any one of Clauses 15-18, wherein the preferred configuration for transmitting an energy signal based on at least one of: a charging rate associated with the UE; channel conditions associated with a channel for transmitting the energy signal; or a frequency range for transmitting the energy signal.
Clause 20: The method of any one of Clauses 15-19, wherein receiving the indication of the preferred configuration from the first UE comprises receiving the indication of the preferred configuration from the first UE in at least one of: a radio resource control (RRC) message; a media access control—control element (MAC-CE) message; a sidelink message; or a physical uplink control channel (PUCCH) message or physical uplink shared channel (PUSCH) message.
Clause 21: The method of any one of Clauses 15-20, further comprising selecting a configuration for transmitting the energy signal to the first UE based, at least in part, on the preferred configuration received from the first UE.
Clause 22: The method of Clause 21, wherein selecting the configuration for transmitting the energy signal to the first UE is based further on at least one of: a charging rate associated with the first UE; channel conditions associated with a channel for transmitting the energy signal; a block error ratio (BLER) associated data transmissions to a second UE; a data rate associated with transmissions to a second UE; or a frequency range for transmitting the energy signal.
Clause 23: The method of any one of Clauses 21-22, further comprising transmitting an indication of selected configuration to the first UE and a second UE including a set of parameters associated with the energy signal.
Clause 24: The method of Clause 23, wherein the set of parameters include a configuration index indicating the selected configuration among a plurality of configurations for transmitting the energy signal.
Clause 25: The method of any one of Clauses 23-24, wherein the set of parameters indicate at least one of: a multiplexing type of the energy signal; a type of waveform of the energy signal; or a modulation type of the energy signal.
Clause 26: The method of Clause 25, wherein modulation type of the energy signal comprises one of: a reference signal (RS)-based modulation type; a circularly symmetric complex Gaussian (CSCG) modulation type; an improper complex Gaussian modulation type; an optimized sequence-based modulation type; an amplitude shift keying (ASK)-based modulation type; a phase shift keying (PSK)-based modulation type; a frequency shift keying (FSK) modulation type; a pulse position modulation (PPM)-based modulation type; a quadrature amplitude modulation (QAM)-based modulation type; an on-off keying (OOK)-based modulation type; a Zadoff Chu-based modulation type; a Bernoulli sequence-based modulation type; or a modulation type based on a known seed or scrambling identifier (ID).
Clause 27: The method of any one of Clauses 25-26, wherein the waveform type for the energy signal comprises one of: a single tone continuous wave waveform type; a multi-tone continuous wave waveform type; a cyclic prefix—orthogonal frequency division multiplexing (CP-OFDM) waveform type; a single carrier quadrature amplitude modulation (SC-QAM) waveform type; or a discrete Fourier transform-spread orthogonal frequency-division multiplexing (DFT-s-OFDM) waveform type.
Clause 28: The method of any one of Clauses 23-27, wherein: the set of parameters indicates a seed or scrambling ID used in generating the energy signal; and the seed or scrambling ID included in the set of parameters is transmitted in a media access control—control element (MAC-CE) message.
Clause 29: The method of any one of Clauses 23-27, further comprising transmitting a set of energy signal sequences in a radio resource control (RRC) or a media access control—control element (MAC-CE) message to the second UE, wherein: the indication of the selected configuration is transmitted in downlink control information (DCI) and includes an indication of an energy signal sequence selected from the set of energy signal sequences.
Clause 30: The method of any one of Clauses 23-27, wherein the set of parameters include a demodulation reference signal (DMRS) configuration, indicating resources associated with the energy signal used for transmitting one or more DMRSs.
Clause 31: The method of Clause 30, wherein the DMRS configuration further indicates at least one of a scrambling ID associated with the one or more DMRSs or a port number associated with the one or more DMRSs.
Clause 32: The method of any one of Clauses 23-31, wherein the indication of the selected configuration is transmitted in a radio resource control (RRC) message or a media access control—control element (MAC-CE) message.
Clause 33: The method of Clause 32, further comprising transmitting an indication of an updated configuration for the energy signal in downlink control information (DCI) or sidelink control information (SCI), wherein transmitting the energy signal is further based on the updated configuration.
Clause 34: A method for wireless communication by a second user equipment (UE), comprising: receiving, from a network entity, an indication of a selected configuration of an energy signal for powering a first UE, the selected configuration of an energy signal including a set of parameters; receiving one or more transmissions from the network entity, the one or more transmissions including the energy signal and one or more data signals; and performing an interference cancellation procedure based on the selected configuration of the energy signal to remove interference caused by the energy signal to the one or more data signals.
Clause 35: The method of Clause 34, wherein the set of parameters include a configuration index indicating the selected configuration among a plurality of configurations for transmitting the energy signal.
Clause 36: The method of any one of Clauses 34-35, wherein the set of parameters indicate at least one of: a multiplexing type of the energy signal; a type of waveform of the energy signal; or a modulation type of the energy signal.
Clause 37: The method of Clause 36, wherein modulation type of the energy signal comprises one of: a reference signal (RS)-based modulation type; a circularly symmetric complex Gaussian (CSCG) modulation type; an improper complex Gaussian modulation type; an optimized sequence-based modulation type; an amplitude shift keying (ASK)-based modulation type; a phase shift keying (PSK)-based modulation type; a frequency shift keying (FSK) modulation type; a pulse position modulation (PPM)-based modulation type; a quadrature amplitude modulation (QAM)-based modulation type; an on-off keying (OOK)-based modulation type; a Zadoff Chu-based modulation type; a Bernoulli sequence-based modulation type; or a modulation type based on a known seed or scrambling identifier (ID).
Clause 38: The method of any one of Clauses 36-37, wherein the waveform type for the energy signal comprises one of: a single tone continuous wave waveform type; a multi-tone continuous wave waveform type; a cyclic prefix—orthogonal frequency division multiplexing (CP-OFDM) waveform type; a single carrier quadrature amplitude modulation (SC-QAM) waveform type; or a discrete Fourier transform-spread orthogonal frequency-division multiplexing (DFT-s-OFDM) waveform type.
Clause 39: The method of any one of Clauses 34-38, wherein: the set of parameters indicates a seed or scrambling ID used in generating the energy signal; and the seed or scrambling ID included in the set of parameters is received in a media access control—control element (MAC-CE) message.
Clause 40: The method of any one of Clauses 34-39, further comprising receiving, from the network entity, a set of energy signal sequences in a radio resource control (RRC) or a media access control—control element (MAC-CE) message, wherein: the indication of the selected configuration is received in downlink control information (DCI) and includes an indication of an energy signal sequence selected from the set of energy signal sequences.
Clause 41: The method of any one of Clauses 34-40, wherein the set of parameters include a demodulation reference signal (DMRS) configuration, indicating resources associated with the energy signal used for transmitting one or more DMRSs.
Clause 42: The method of Clause 41, wherein the DMRS configuration further indicates at least one of a scrambling ID associated with the one or more DMRSs or a port number associated with the one or more DMRSs
Clause 43: The method of any one of Clauses 34-42, wherein: the energy signal and the one or more data signals are beamformed using same precoder, and the method further comprises using the energy signal to perform channel estimation associated with the one or more data signals.
Clause 44: The method of any one of Clauses 34-43, wherein the indication of the selected configuration is received in a radio resource control (RRC) message or a media access control—control element (MAC-CE) message.
Clause 45: The method of Clause 44, further comprising receiving an indication of an updated configuration for the energy signal in downlink control information (DCI) or sidelink control information (SCI), wherein performing the interference cancellation procedure is further based on the updated configuration.
Clause 46: An apparatus, comprising: a memory comprising executable instructions; and a processor configured to execute the executable instructions and cause the apparatus to perform a method in accordance with any one of Clauses 1-45.
Clause 47: An apparatus, comprising means for performing a method in accordance with any one of Clauses 1-45.
Clause 48: A non-transitory computer-readable medium comprising executable instructions that, when executed by a processor of an apparatus, cause the apparatus to perform a method in accordance with any one of Clauses 1-45.
Clause 49: A computer program product embodied on a computer-readable storage medium comprising code for performing a method in accordance with any one of Clauses 1-45.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a first user equipment (UE), comprising:
transmitting, to a network entity, an indication of a preferred configuration for transmission of an energy signal to power one or more components of the first UE; and
receiving the energy signal from the network entity based, at least in part, on the preferred configuration.

2. The method of claim 1, further comprising harvesting energy from the energy signal to power the one or more components of the first UE.

3. The method of claim 2, further comprising storing a portion of the harvested energy from the energy signal in a power storage component of the first UE.

4. The method of claim 1, wherein the preferred configuration comprises a set of parameters indicating at least one of:
a multiplexing type for the energy signal with data;
a waveform type for the energy signal; or
a modulation type for the energy signal.

5. The method of claim 4, wherein the modulation type for the energy signal comprises one of:
a reference signal (RS)-based modulation type;
a circularly symmetric complex Gaussian (CSCG) modulation type;
an improper complex Gaussian modulation type;
an optimized sequence-based modulation type;
an amplitude shift keying (ASK)-based modulation type;
a phase shift keying (PSK)-based modulation type;
a frequency shift keying (FSK) modulation type;
a pulse position modulation (PPM)-based modulation type;
a quadrature amplitude modulation (QAM)-based modulation type;
an on-off keying (OOK)-based modulation type;
a Zadoff Chu-based modulation type; or
a Bernoulli sequence-based modulation type.

6. The method of claim 4, wherein the waveform type for the energy signal comprises one of:
a single tone continuous wave waveform type;
a multi-tone continuous wave waveform type;
a cyclic prefix—orthogonal frequency division multiplexing (CP-OFDM) waveform type;
single carrier quadrature amplitude modulation (SC-QAM) waveform type; or
a discrete Fourier transform-spread orthogonal frequency-division multiplexing (DFT-s-OFDM) waveform type.

7. The method of claim 1, further comprising determining the preferred configuration for transmitting an energy signal based on at least one of:
a charging rate associated with the first UE;
channel conditions associated with a channel for transmitting the energy signal; or
a frequency range for transmitting the energy signal.

8. The method of claim 1, wherein transmitting the indication of the preferred configuration to the network entity comprises transmitting the indication of the preferred configuration to the network entity in at least one of:
a radio resource control (RRC) message;
a media access control—control element (MAC-CE) message;
a sidelink message; or
a physical uplink control channel (PUCCH) message or physical uplink shared channel (PUSCH) message.

9. The method of claim 1, further comprising:
receiving an indication of a selected configuration for the energy signal from the network entity, wherein:
the selected configuration for the energy signal is based, at least in part, on the preferred configuration transmitted to the network entity, and
receiving the energy signal from the network entity is further based on the selected configuration.

10. The method of claim 9, further comprising:
receiving one or more data signals; and
performing an interference cancellation procedure based on the selected configuration for the energy signal to remove interference caused by the energy signal to the one or more data signals.

11. The method of claim 9, wherein the indication of the selected configuration is received in a radio resource control (RRC) message or a media access control—control element (MAC-CE) message.

12. The method of claim 11, further comprising:
receiving an indication of an updated configuration for the energy signal in downlink control information (DCI) or sidelink control information (SCI),
wherein receiving the energy signal is further based on the updated configuration.

13. The method of claim 1, wherein the first UE comprises one of:
a semi-passive or semi-active low-power communication device;
an active communication device;
a passive internet of things (PIoT) device; or
a backscattering-based communication device.

14. The method of claim 1, wherein:
the energy signal and one or more data signals are beamformed using same precoder; and
the method further comprises using the energy signal to perform channel estimation associated with the one or more data signals.

15. A method for wireless communication by a network entity, comprising:
receiving, from a first use equipment (UE), an indication of a preferred configuration for transmission of an energy signal to power one or more components of the first UE; and
transmitting the energy signal based, at least in part, on the preferred configuration.

16. The method of claim 15, wherein the preferred configuration comprises a set of parameters indicating at least one of:
a multiplexing type for the energy signal with data;
a waveform type for the energy signal; or
a modulation type for the energy signal.

17. The method of claim 16, wherein modulation type for the energy signal comprises one of:
a reference signal (RS)-based modulation type;
a circularly symmetric complex Gaussian (CSCG) modulation type;
an improper complex Gaussian modulation type;
an optimized sequence-based modulation type;
an amplitude shift keying (ASK)-based modulation type;
a phase shift keying (PSK)-based modulation type;
a frequency shift keying (FSK) modulation type;
a pulse position modulation (PPM)-based modulation type;
a quadrature amplitude modulation (QAM)-based modulation type;
an on-off keying (OOK)-based modulation type;
a Zadoff Chu-based modulation type; or
a Bernoulli sequence-based modulation type.

18. The method of claim 16, wherein the waveform type for the energy signal comprises one of:
a single tone continuous wave waveform type;
a multi-tone continuous wave waveform type;
a cyclic prefix—orthogonal frequency division multiplexing (CP-OFDM) waveform type;
single carrier quadrature amplitude modulation (SC-QAM) waveform type; or
a discrete Fourier transform-spread orthogonal frequency-division multiplexing (DFT-s-OFDM) waveform type.

19. The method of claim 15, wherein the preferred configuration for transmitting an energy signal based on at least one of:
a charging rate associated with the UE;
channel conditions associated with a channel for transmitting the energy signal; or
a frequency range for transmitting the energy signal.

20. The method of claim 15, wherein receiving the indication of the preferred configuration from the first UE comprises receiving the indication of the preferred configuration from the first UE in at least one of:
a radio resource control (RRC) message;
a media access control—control element (MAC-CE) message;
a sidelink message; or
a physical uplink control channel (PUCCH) message or physical uplink shared channel (PUSCH) message.

21. The method of claim 15, further comprising:
selecting a configuration for transmitting the energy signal to the first UE based, at least in part, on the preferred configuration received from the first UE; and
transmitting an indication of selected configuration to the first UE and a second UE including a set of parameters associated with the energy signal.

22. The method of claim 21, wherein selecting the configuration for transmitting the energy signal to the first UE is based further on at least one of:
a charging rate associated with the first UE;
channel conditions associated with a channel for transmitting the energy signal;
a block error ratio (BLER) associated data transmissions to a second UE;
a data rate associated with transmissions to a second UE; or
a frequency range for transmitting the energy signal.

23. The method of claim 21, wherein the set of parameters include a configuration index indicating the selected configuration among a plurality of configurations for transmitting the energy signal.

24. The method of claim 21, wherein the set of parameters indicate at least one of:
a multiplexing type of the energy signal;
a type of waveform of the energy signal; or
a modulation type of the energy signal.

25. The method of claim 21, wherein:
the set of parameters indicates a seed or scrambling ID used in generating the energy signal; and
the seed or scrambling ID included in the set of parameters is transmitted in a media access control—control element (MAC-CE) message.

26. The method of claim 21, further comprising transmitting a set of energy signal sequences in a radio resource control (RRC) or a media access control—control element (MAC-CE) message to the second UE, wherein:
the indication of the selected configuration is transmitted in downlink control information (DCI) and includes an indication of an energy signal sequence selected from the set of energy signal sequences.

27. The method of claim 21, wherein:
the set of parameters include a demodulation reference signal (DMRS) configuration, indicating resources associated with the energy signal used for transmitting one or more DMRSs, and
the DMRS configuration further indicates at least one of a scrambling ID associated with the one or more DMRSs or a port number associated with the one or more DMRSs.

28. The method of claim 21, wherein:
the indication of the selected configuration is transmitted in a radio resource control (RRC) message or a media access control—control element (MAC-CE) message,
the method further comprises transmitting an indication of an updated configuration for the energy signal in downlink control information (DCI) or sidelink control information (SCI), and
transmitting the energy signal is further based on the updated configuration.

29. An apparatus, comprising:
a memory comprising executable instructions; and
a processor configured to execute the executable instructions and cause the apparatus to:
transmit, to a network entity, an indication of a preferred configuration for transmission of an energy signal to power one or more components of the apparatus; and
receive the energy signal from the network entity based, at least in part, on the preferred configuration.

30. An apparatus, comprising:
a memory comprising executable instructions; and
a processor configured to execute the executable instructions and cause the apparatus to:
receive, from a first user equipment (UE), an indication of a preferred configuration for transmission of an energy signal to power one or more components of the first UE; and
transmit the energy signal based, at least in part, on the preferred configuration.
